(19) United States
(12) Patent Application Publication
(10) Pub. No.: US 2019/0043104 A1
(43) Pub. Date: Feb. 7, 2019

(54) LIVE VIDEO COMMUNICATION SYSTEMS AND METHODS FOR TRADE SERVICES

(71) Applicant: Tommy Bonnet, Crowborough (GB)

(72) Inventor: Tommy Bonnet, Crowborough (GB)

(21) Appl. No.: 16/149,153

(22) Filed: Oct. 2, 2018

(51) Int. Cl. G06Q 30/06; H04N 7/14; G06Q 20/12; G06Q 30/02

(52) U.S. Cl. CPC G06Q 30/0611; G06Q 30/0283; G06Q 20/12; H04N 7/147

(57) ABSTRACT

A live video communication system comprising a transceiving module for receiving a job request for a live video call or a home visit from a consumer is disclosed. A job request notification is sent to multiple tradesmen based on the job request and a list of tradesman may be displayed to the consumer. A selection of a tradesman from the consumer or an acceptance of the job request is receives from a tradesman and job is assigned accordingly to a tradesman. A communication module may arrange at least one of a live video call session or a home visit of the tradesman at the location of the consumer based on the job request. A payment managing module may calculate a fee for the job on completion of the live video call or the home visit and charge an account of the consumer according to the calculated fee.

### TECHNICAL FIELD

The presently disclosed subject matter generally relates to the field of communication with tradesman for trade services. More particularly, the present disclosure relates to live video communication systems and methods for emergency trade services, which arranges at least one of a live video call session between a tradesman and a consumer or a home visit of the tradesman at a location of the consumer.

### BACKGROUND

With the advent of Internet, almost everything, be it a product or service, is available online. These days almost everyone is using smart devices to connect to the Internet on daily basis for multiple purposes like entertainment and knowledge. People rely on Internet for finding solution to many problems related to their day-to-day life such as finding a good Thai restaurant, finding an engineering college, side effects of a medicine, finding an electrician, and so forth. Millions of people require tradesman for a variety of trade services like housecleaning, plumbing, air-conditioning, electrical, flooring, and so forth on a regular basis or in an emergency situation. A tradesman also referred, as a tradesperson, tradie or a skilled tradesman may be a worker specialized in a particular occupation.

For accomplishing different type of work, a different tradesman may be required. For example, the people may require tradesman in the fields of construction, drywall, plumbing, electrical, heating, ventilation and air conditioning (“HVAC”), flooring, painting, windows, doors, millwork and/or the like. Sometimes, the process of finding and locating a right tradesman for doing the job right may be a difficult task for the consumers. Sometimes, the consumers are aware of the issue, but they are not able to identify which type of tradesman will be able to fix it. For example, smoke coming out of air-conditioning duct, then a consumer would not know if the problem is with the air conditioning system or with the electrical wiring, hence may not be able to identify if he/she need to contact an electrician or an air-conditioning tradesman. In addition to finding and locating the right tradesman in the necessary trades, the consumer may have difficulty in procuring the tradesman within the immediate area of the site or location. If the consumer has selected a tradesman then also the tradesman is able to check the issue after arriving at the site only and the tradesman starts the process of fixing it accordingly. Nothing can actually be done until the tradesman has not arrived at the site or location of the emergency. Sometimes, after checking the issue, the tradesman may realize that he require some extra resources for fixing it, then the tradesman may take more time to arrange those resources.

Another issue is the tradesmen may not be familiar with the locality or the site/location, in turn the tradesman may also fail to arrive at the site/location in time, and this may sometimes result in dangerous consequences for the consumer in case of emergency situation. Further, to locate the tradesman locally, people rely either on local contacts, phone directory, or on search results that they get by searching on the Internet. The search results may or may not be of skilled tradesman. The consumers usually call the tradesman to explain the emergency situation or the requirement in words, and accordingly the tradesman may decide to come. But the tradesman gets an actual picture of the situation only after arriving at the site of emergency. The tradesman cannot see the site live over phone before arriving at the site. This may limit the tradesman capability, as after arriving at the site, the tradesman may realize that some other type of tradesman or tool are also required to fix the situation.

In light of above, there exists a need for improved techniques of procuring tradesman for emergency trade services.

### SUMMARY

The present disclosure provides an innovative web platform for helping users such as, but not limited to, home owners to find and connect to a tradesman for trade services such as, plumbing, home cleaning etc. via a live video call or a home visit of the tradesmen with an emergency or urgent priority.

The present disclosure provides live video communication systems and methods for emergency trade services, which arranges at least one of a live video call session between a tradesman and a consumer or a home visit of the tradesman at a location of the consumer. The tradesman and the consumer may be using different type of computing devices having different type of operating system.

The present disclosure provides a live video calling system for emergency trade services for establishing a live video call session between a tradesman and a consumer or arrange an emergency home visit of a tradesman at a location of the consumer in case of an emergency situation based on a mode of communication selected by the consumer.

An objective of the present disclosure is to provide a live video communication system for connecting to a tradesman for emergency trade services. A consumer can connect to a live video communication system via a website or an application running on an associated computing device. The consumer can send a job request for a live video call or home call out (or home visit) of a tradesman in case of an emergency situation to the live video communication system. The live video communication system may send a job request notification for at least one of the live video calls or the home call out to a plurality of tradesman present in a local area of the consumer. In some embodiments, at least one of the pluralities of tradesman may accept the job request. The at least one of the pluralities of tradesman may accept the job request based on a first come first serve basis and may win a job. In alternative embodiments, the live video communication system presents a list of the plurality of tradesman to the consumer, and the consumer may select at least one of the pluralities of tradesman from the list. The consumer may accept terms and conditions. After at least one of the selections of the at least one tradesman from the list and acceptance of the job request by the at least one tradesman, a live video call session may be established between the consumer and the at least one tradesman. After call a fee/money may be automatically calculated according to a time spend on the call and may be charged per minute for the call service with agreed fee to make the call. In some embodiments, the calculated fee/money may be automatically deducted from an account of the consumer. In some embodiments, the consumer may request a home call out service, and then at least one tradesman may accept the home call out request. The at least one tradesman may have to visit a location of the consumer within a fixed timeframe. If the tradesman is not able to reach at the location within the fixed timeframe, then the tradesman may be charged a delay fee or may lose a deposit for the home visit.

An embodiment of the present disclosure provides a live video communication system for trade services. The live video communication system includes a transceiving module configured to provide two modes of communication comprising a live video call and a home visit to a consumer, wherein the consumer selects at least one mode of the two modes. The transceiving module is also configured to receive a job request for at least one of a live video call or a home visit based on the selection of the at least one mode, and an acceptance of terms and conditions from the consumer, wherein the job request is for contacting a tradesman for a trade service. The transceiving module is also configured to send a job request notification to a plurality of tradesman based on the job request, wherein a list of the plurality of tradesman is displayed to the consumer until an acceptance of the job request is not received from any tradesman. The transceiving module is also configured to receive at least one of a selection of a tradesman of the list from the consumer and an acceptance of the job request from a tradesman of the plurality of tradesman. The system also includes a job managing module configured to assign a job to at least one tradesman of the tradesman selected by the consumer and the tradesman who accepted the job request, wherein one or more details of the consumer comprising a location of the consumer are sent to the at least one tradesman for assigning the job. The system also includes a communication module configured to arrange at least one of a live video call session between the consumer and the at least one tradesman or a home visit of the at least one tradesman at the location of the consumer based on the selection of the at least one mode. The system further includes a payment managing module configured to calculate a fee for the job based on one or more parameters on completion of at least one of the live video calls or the home visit, wherein the one or more parameters comprising a duration of the job, a type of the at least one tradesman, a type of the trade service, and the terms and conditions; and charge an account of the consumer according to the calculated fee.

According to an aspect of the present disclosure, the communication module is also configured to prompt the consumer to confirm ending the live video call after receiving an end call request from the consumer to double check with the consumer and ending the live video call session upon receiving an end call confirmation input from the consumer.

According to another aspect of the present disclosure, the at least one tradesman is committed to arrive at the location within a timeframe after accepting the job request.

According to another aspect of the present disclosure, the payment managing module is configured to make a payment to the at least one tradesman for a completed job based on one or more factors.

According to another aspect of the present disclosure, the job request is accepted by the tradesman of the plurality of tradesman based on first come first serve basis.

According to another aspect of the present disclosure, the transceiving module is configured to share one or more details of the at least one tradesman with the consumer after assignment of the job, wherein the consumer initiates the live video call session with the at least one tradesman.

According to another aspect of the present disclosure, the transceiving module is configured to receive a job completion notification from the consumer based on at least one of an end of the live video call session or completion of the home visit.

According to another aspect of the present disclosure, the job request notification comprises a short description of a job and a distance between the location of the consumer and the at least one tradesman.

According to another aspect of the present disclosure, the location of the consumer is sent to the at least one tradesman by using a Geo Positioning System (GPS).

Another embodiment of the present disclosure provides a method for method for live video communication for trade services. The method includes providing two modes of communication comprising a live video call and a home visit to a consumer, wherein the consumer selects at least one mode of the two modes. The method also includes receiving a job request for at least one of a live video call or a home visit based on the selection of the at least one mode, and an acceptance of terms and conditions from the consumer, wherein the job request is for contacting a tradesman for a trade service. The method also includes sending a job request notification to a plurality of tradesman based on the job request, wherein a list of the plurality of tradesman is displayed to the consumer until an acceptance of the job request is not received from any tradesman. The method also includes receiving at least one of a selection of a tradesman of the list from the consumer and an acceptance of the job request from a tradesman of the plurality of tradesman. The method further includes assigning a job to at least one tradesman of the tradesman selected by the consumer and the tradesman who accepted the job request, wherein one or more details of the consumer comprising a location of the consumer are sent to the at least one tradesman for assigning the job. The method also includes arranging at least one of a live video call session between the consumer and the at least one tradesman or a home visit of the at least one tradesman at the location of the consumer based on the selection of the at least one mode. The method also includes calculating a fee for the job based on one or more parameters on completion of at least one of the live video calls or the home visit, wherein the one or more parameters comprising a duration of the job, a type of the at least one tradesman, a type of the trade service, and the terms and conditions. The method also includes charging an account of the consumer according to the calculated fee.

According to an aspect of the present disclosure, the consumer is prompted to confirm ending the live video call after receiving an end call request from the consumer to double check with the consumer and ending the live video call upon receiving an end call confirmation input from the consumer

According to another embodiment of the present disclosure, a payment is made to the at least one tradesman for a completed job based on one or more factors like duration of the job, skill of the tradesman, terms and conditions, and so forth.

According to an aspect of the present disclosure, a delay fee is charged when the at least one tradesman is not able to reach at the location of the consumer within the time frame.

According to an aspect of the present disclosure, the tradesman of the plurality of tradesman accepts the job request based on first come first serve basis.

According to an aspect of the present disclosure, one or more details of the at least one tradesman are shared with the consumer after assignment of the job, wherein the consumer initiates the live video call session with the at least one tradesman.

According to an aspect of the present disclosure, a job completion notification is received from the consumer based on at least one of an end of the live video call session or completion of the home visit.

Another embodiment of the present disclosure provides a live video communication system for managing a communication between a tradesperson and a consumer for an emergency trade service. The system includes a transceiving module configured to provide two modes of communication comprising a live video call and a home visit to a consumer, wherein the consumer selects at least one mode of the two modes. The transceiving module is also configured to receive a job request for at least one of a live video call or a home visit based on the selection of the at least one mode, and an acceptance of terms and conditions from the consumer. The job request is for contacting a tradesperson for an emergency trade service. The transceiving module is also configured to send a job request notification based on the job request to a plurality of tradesperson present in a local area of the consumer. The job request notification may include a short description of a job and a distance between a location of the consumer and the at least one tradesperson. A list of the plurality of tradesperson may be displayed to the consumer until an acceptance of the job request is not received from any tradesperson. The transceiving module is also configured to receive at least one of a selection of a tradesperson of the list from the consumer and an acceptance of the job request from a tradesperson of the plurality of tradesperson. The system includes a job managing module configured to assign the job to at least one tradesperson of the tradesperson selected by the consumer and the tradesperson who accepted the job request. The location of the consumer is sent to the at least one tradesperson by using a Geo Positioning System (GPS) for assigning the job, wherein one or more details of the at least one tradesperson are shared with the consumer after assignment of the job. The system includes a communication module configured to arrange at least one of a live video call session between the consumer and the at least one tradesperson or a home visit of the at least one tradesperson at the location of the consumer based on the selection of the at least one mode. The system also includes a payment managing module configured to calculate a fee for the job based on one or more parameters comprising a duration of the job, a type of the at least one tradesperson, a type of the trade service, and the terms and conditions after completion of the job. The payment managing module is also configured to charge an account of the consumer according to the calculated fee; and make a payment to the at least one tradesperson for the job based on one or more factors. The transceiving module may receive a job completion notification from the consumer based on at least one of an end of the live video call session or completion of the home visit.

According to an aspect of the present disclosure, the communication module is also configured to prompt the consumer to confirm ending the live video call after receiving an end call request from the consumer to double check with the consumer and ending the live video call upon receiving an end call confirmation input from the consumer.

According to another embodiment of the present disclosure, the consumer uses a first computing device having a first operating system and the tradesman using a second computing device having a second operating system.

These together with the other aspects of the present disclosure, along with the various features of novelty that characterize the present disclosure, are pointed out with particularity in the present disclosure. For a better understanding of the present disclosure, its operating advantages, and its uses, reference should be made to the accompanying drawings and descriptive matter in which there are illustrated exemplary embodiments of the present disclosure.

### BRIEF DESCRIPTION OF THE DRAWINGS

The foregoing summary, as well as the following detailed description of various embodiments, is better understood when read in conjunction with the drawings provided herein. For the purposes of illustration, there is shown in the drawings exemplary embodiments; however, the presently disclosed subject matter is not limited to the specific methods and instrumentalities disclosed.

FIG. 1 illustrates an exemplary environment where various embodiments of the present disclosure may function;

FIG. 2 is a block diagram illustrating system elements of a live video communication system, in accordance with an embodiment of the present disclosure; and

FIGS. 3A-3C is a flowchart illustrating a method for establishing a communication session between a consumer and a tradesman, in accordance with an embodiment of the present disclosure.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

As used herein, a module may refer to a device or combination of devices that may include hardware, software, firmware, or combination of these. The module may be machine-implemented instructions.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

All numeric values are herein assumed to be modified by the term “about,” whether or not explicitly indicated. The term “about” generally refers to a range of numbers that one of skill in the art would consider equivalent to the recited value (i.e., having the same or substantially the same function or result). In many instances, the terms “about” may include numbers that are rounded to the nearest significant figure. The recitation of numerical ranges by endpoints includes all numbers within that range (e.g., 1 to 5 includes 1, 1.5, 2, 2.75, 3, 3.80, 4, and 5).

The following detailed description should be read with reference to the drawings, in which similar elements in different drawings are identified with the same reference numbers. The drawings, which are not necessarily to scale, depict illustrative embodiments and are not intended to limit the scope of the disclosure.

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements and components comprising one unit and elements or components that comprise more than one unit unless specifically stated otherwise.

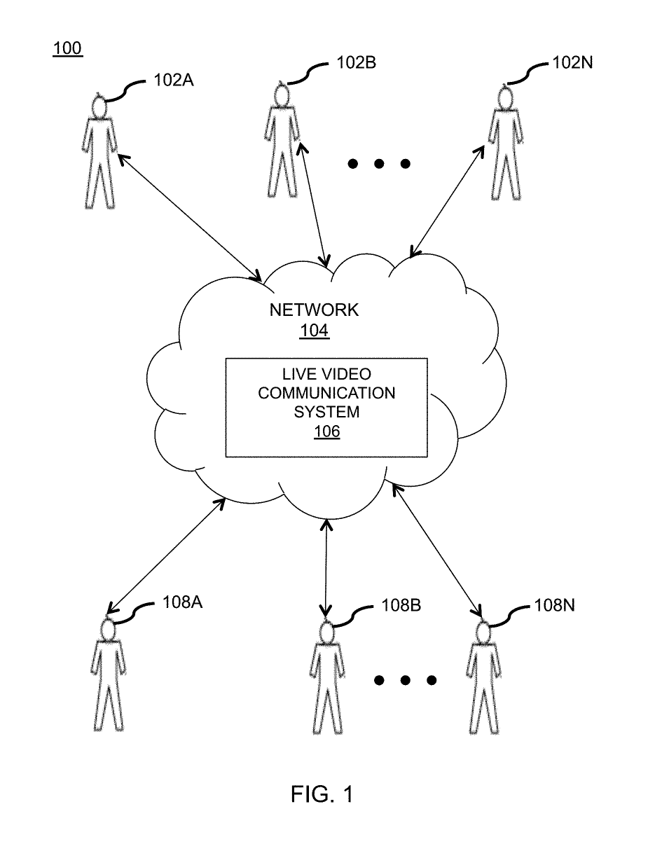

FIG. 1 illustrates an exemplary environment 100 where various embodiments of the present disclosure may function. As shown, the environment 100 primarily includes a plurality of consumers 102A-102N, a network 104, a live video communication system 106, and a plurality of tradesman 108A-108N. The consumers 102A-102N may be any person like homeowner who can request trade services in the field of such as, but not limited to, construction, drywall, plumbing, electrical, heating, ventilation and air conditioning (“HVAC”), flooring, painting, windows, doors, millwork and/or the like. Herein after, a tradesman of the plurality of tradesman 108A-108N may also be referred as a tradesman 108, tradesperson 108, tradie 108 or a skilled tradesman 108. The tradesman 108 may be a worker specialized in a particular occupation. Hereinafter a consumer of the consumers 102A-102N may be referred as a consumer 102. The consumers 102A-102N may connect to the network 104 for accessing the live video communication system 106. Examples of the network 104 may include, but are not limited to, Internet, a Wide Area Network (WAN), a Local Area Network (LAN), a Metropolitan Area Network (MAN), and so forth. In some embodiments, the live video communication system 106 may be a web platform. In some embodiments, the consumers 102A-102N may connect to the network 104 by using an associated computing device (not shown). Examples of the computing device may include, but are not limited to, a computer, a laptop computer, a tablet computer, a smart watch, a smart phone, a personal digital assistant, and so forth.

The live video communication system 106 may enable users like consumers 102A-102N and the tradesman 108A-18N using different computing devices having different platforms or operating systems, such as, but not limited to, iOS, Symbian, Windows, Android, and so forth to contact each other via live video call.

In some embodiments, the live video communication system 106 may be accessed as a website. The consumer 102 may access the live video communication system 106 by entering a uniform resource locator (URL) in a web browsing application on the computing device. In alternative embodiments, the live video communication system 106 may be cloud network-based system. In some embodiments, the live video communication system 106 may be a software application running on the computing device of the consumer 102. Further, the live video communication system 106 may be a single device or a combination of multiple devices. In some embodiments, the live video communication system 106 may include hardware, software, firmware, or combination of these.

The consumers 102A-102N may connect to the live video communication system 106 for hiring a tradesman 108 for a trade service or an emergency trade service. In some embodiments, the consumers 102A-102N and the tradesman 108A-108N register with the live video communication system 106 for accessing the live video communication system 106 by using one or more details. The one or more details required for registration may include, but are not limited to, a name, an age, a location or address, bank account information, password, username, gender, email address, and so forth. In some embodiments, the consumers 102A-102N may be asked to provide associated payment details at a time of signup or registration with the live video communication system 106. The consumers 102A-102N may connect to the network 104 and access the live video communication system 106 for requesting a communication session with one or more of the plurality of tradesman 108A-108N for trade services or emergency trade services. The communication session may be a live video call between the consumer 102 and the tradesman 108 or the communication session may be a home visit of a tradesman of the tradesman 108A-108N at a location of a consumer of the consumers 102A-102N.

A consumer such as the consumer 102A may have to enter his/her login credentials for accessing the live video communication system 106 on his/her computing device. The live video communication system 106 may authenticate the consumer 102A based on the entered login credentials. The live video communication system 106 may provide the consumer 102A with two modes of communication comprising a live video call and a home visit to the consumer 102A. The consumer 102A may select at least one mode of the two modes. The live video communication system 106 may receive a job request for at least one of a live video call or a home visit based on the selection of the at least one mode, and an acceptance of terms and conditions from a consumer such as the consumer 102A. In some embodiments, the consumer 102A may accept the terms and conditions at the time of sending a job request. In alternate embodiments, the consumers 102A-102N may accept the terms and conditions at the time of registration with the live video communication system 106. The job request may be for contacting a tradesman of the tradesman 108A-108N for a trade service or an emergency trade service. In some embodiments, the live video communication system 106 may inform the consumer 102A about a charge of selected service like live video call communication or home visit. The charge may be an approximate or exact charge. For example, the charge may be like $5 per minute of call or home $10 for per minute of home visit, after completion of the job, the fee may be calculated according to the duration of the job and the charge as agreed upon initially.

The live video communication system 106 may send a job request notification to the plurality of tradesman 108A-108N based on the job request. The job request notification may include a short description of a job and a distance between the location of the consumer 102A and the at least one tradesman (or the tradesman 108A-108N). Further, the live video communication system 106 may display a list of the plurality of tradesman 108A-108N to the consumer 102A until an acceptance of the job request is not received from any of the plurality of tradesman 108A-108N.

Also, each of the plurality of tradesman 108A-108N uses a suitable computing device such as, but not limited to, a smart phone, to connect to the live video communication system 106 and receive the job request notification from the live video communication system 106 on the computing device.

The live video communication system 106 may receive at least one of a selection of a tradesman like a tradesman 108A of the list from the consumer 102A and an acceptance of the job request from a tradesman e.g. tradesman 108B of the plurality of tradesman 108A-108N. In some embodiments, when the consumer 102A selects the tradesman 108A before any acceptance of the job request is received from the tradesman 108B, then the tradesman 108A wins the job. In other embodiments, if the acceptance of the job request is received from the tradesman 108B before receiving the selection of the tradesman 108A, then the tradesman 108B wins the job. In alternate embodiments, the tradesman 108A selected by the consumer 102A is given priority and may win the job even if the acceptance of the job request from the tradesman 108B is received before the selection of the tradesman 108A by the consumer 102A. For the sake of describing the functionality of the live video communication system 106, lets assume that the tradesman 108B wins accepts the job request and wins the job.

The live video communication system 106 is also configured to assign a job to at least one tradesman i.e. 104A or 104B of the tradesman 108A selected by the consumer 102A and the tradesman 108B who accepted the job request. The job request is accepted by the tradesman 108B of the plurality of tradesman 108A-108N based on first come first serve basis. In some embodiments, the job may be assigned to a tradesman based on at least one of a proximity to the location, a response from the tradesman 108B, a received selection of the tradesman 108A from the consumer 102A, a skillset of the tradesman, a timeframe commitment of the tradesman for reaching at the location, and so forth. The live video communication system 106 is configured to send one or more details of the consumer 102A comprising a location, a name etc. of the consumer 102A to the at least one tradesman 108B for assigning the job. The location of the consumer 102A may be sent to the at least one tradesman 108B by using a Geo Positioning System (GPS).

The live video communication system 106 is also configured to arrange at least one of a live video call session between the consumer 102A and the at least one tradesman 108B or a home visit of the at least one tradesman 108B at the location of the consumer 102 based on the selection of the at least one mode of communication. For example, if the consumer 102A selected live video call session mode then a live video call session may be established between the consumer 102A and the tradesman 108B. In some embodiments, the consumer 102A initiates the live video call session with the at least one tradesman 108B. The live video communication system 106 may link any user comprising the consumers 102A-102N or the plurality of tradesman 108A-108N using any computing device platform through a website or application to connect via the live video call. Further, the tradesman 108B, like a plumber, can use a camera lens of the computing device of the consumer 102A to zoom in and out to help make the experience less stressful for the consumer 102A. So the consumer 102A can just hold the computing device, like phone, to show the tradesman 108B on camera the problem so the consumer 102A and the tradesman 108B can use their hands and hold the computing device at the same time. Also, the tradesman 108B can turn torch on consumer's computing device to help solve the problem.

Further, the consumer 102A may end the call for ending the live video call session. The live video communication system 106 may prompt the consumer 102A to confirm ending the live video call after receiving an end call request from the consumer 102N to double check with the consumer 102N. The live video call session may be ended upon receiving an end call confirmation input from the consumer. Therefore, the live video communication system 106 is a two-touch end call system to help stop ending the live video call by accident. In some embodiments, the tradesman 108B may send an email to the consumer 102A after their recorded live video call/chat session via the live video communication system 106 for future reference of the consumer 102A.

In an embodiment, when the consumer 102A selected a home visit mode of communication then the tradesman may have reach at a location of the consumer 102A. In case of the home visit mode of communication selection by the consumer 102A, the tradesman 108B wins the job for emergency home visit or home call out, then automatically after call maps will pin point consumer location for the tradesman 108B to use as GPS to get to the destination ASAP to help the consumer 102A at the location in emergency. The transceiving module 204 may receive a job completion notification from the consumer 102A based on at least one of an end of the live video call session or completion of the home visit. The at least one tradesman 108B may be committed to arrive at the location within a timeframe after accepting the job request. The tradesman 108B may be charged with a delay fee or an amount may be deducted from an account of the tradesman 108B.

The live video communication system 106 also calculates a fee for the job based on one or more parameters on completion of at least one of the live video calls or the home visit. In some embodiments, the fee may be calculated per minute for the length time of the live video call. The one or more parameters comprising a duration of the job, a type of the at least one tradesman 108B, a type of the trade service, and the terms and conditions. In some embodiments, the live video communication system 106 may automatically charge an account of the consumer 102A according to the calculated fee. In alternative embodiments, the consumer 102A may receive a payment link for paying for the job as per the calculated fee, and then the consumer 102A may follow the link to pay for the completed job. This way the consumers who are not comfortable in providing their payment or bank information at time of registration can pay for the job after completion of the job.

In some embodiments, the consumer 102A can leave or provide a review after they have paid for the job, this way the review will be a genuine review and not a fake review by anyone who has never availed a trade service.

The live video communication system 106 may be configured to make a payment to the at least one tradesman for a completed job based on one or more factors. The one or more factors may include, but are not limited to, time of arrival at the location, duration of the live video call, duration of the home visit, skill of the tradesman 108B, transport allowance, and so forth. In some embodiments, the live video communication system 106 may charge the consumer 102A and the tradesman 108B for establishing the communication between them as a service fee.

The live video communication system 106 may work for all types of platforms or operating systems, such as, but not limited to, iOS, Symbian, Windows, Android, and so forth, of computing devices and for all types of computing devices.

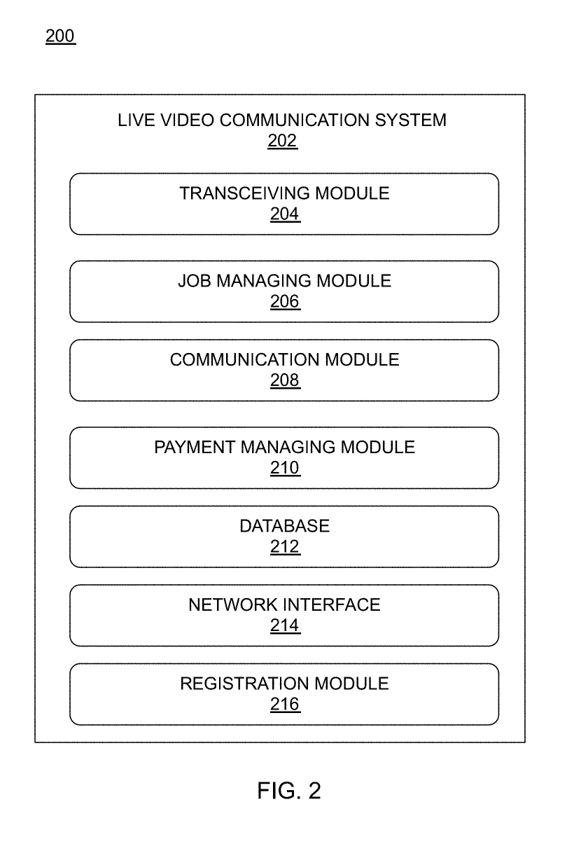

FIG. 2 is a block diagram 200 illustrating system elements of a live video communication system 202, in accordance with an embodiment of the present disclosure. As shown, the live video communication system 202 may primarily include a transceiving module 204, a job-managing module 206, a communication module 208, a payment managing module 210, a database 212, a network interface 214, and a registration module 216. The live video communication system 202 may enable users like consumers 102A-102N and the tradesman 108A-18N using different computing devices having different platforms or operating systems, such as, but not limited to, iOS, Symbian, Windows, Android, and so forth to contact each other via live video call as discussed with reference to FIG. 1.

In some embodiments, the live video communication system 202 may be accessed as a website. The consumer 102 may access the live video communication system 202 by entering a uniform resource locator (URL) in a web browsing application on the computing device. In alternative embodiments, the live video communication system 202 may be cloud network-based system. In some embodiments, the live video communication system 202 may be a software application running on the computing device of the consumer 102. Further, the live video communication system 202 may be a single device or a combination of multiple devices. In some embodiments, the live video communication system 202 may include hardware, software, firmware, or combination of these.

The consumers 102A-102N may connect to the live video communication system 202 for hiring a tradesman 108 for a trade service or an emergency trade service. In some embodiments, the consumers 102A-102N and the tradesman 108A-108N register with the live video communication system 202 for accessing the live video communication system 106 by using one or more details. The one or more details required for registration may include, but are not limited to, a name, an age, a location or address, bank account information, password, username, gender, email address, and so forth. In some embodiments, the consumers 102A-102N may be asked to provide associated payment details at a time of signup or registration with the live video communication system 106. The registration module 216 may register the consumers 102A-102N and the tradesman 108A-108N with the live video communication system 202.

Further, the consumers 102A-102N may connect to the network 104 and access the live video communication system 202 for requesting a communication session with one or more of the plurality of tradesman 108A-108N for trade services or emergency trade services. The communication session may be a live video call between the consumer 102 and the tradesman 108 or the communication session may be a home visit of a tradesman of the tradesman 108A-108N at a location of a consumer of the consumers 102A-102N. Lets assumer a consumer 102A of the consumers 102A-102N connects with the live video communication system 202 for contacting a tradesman for an emergency trade service. The consumer 102A may have to enter his/her login credentials for accessing the live video communication system 106 on his/her computing device. The registration module 216 may authenticate the consumer 102A based on the entered login credentials. The login credentials of the registered consumers 102A-102N and the registered tradesman 108A-108N may be stored in the database 212.

The transceiving module 204 is configured to provide two modes of communication comprising a live video call/chat mode of communication and a home visit mode of communication to the consumer 102A. The consumer 102A may select at least one mode of the two modes of communication. Lets assume for describing the functionality of the live video communication system 202 that the consumer 102A selects a live video call (or chat) mode of communication. The transceiving module 204 may receive a job request for at least one of a live video call or a home visit based on the selection of the at least one mode, and an acceptance of terms and conditions from the consumer 102A. In some embodiments, the consumer 102A may accept the terms and conditions of usage and service at the time of registration. In alternative embodiments, the consumer 102A may accept the terms and conditions of usage and service at the time of sending the job request. The job request may be for contacting a tradesman for a trade service. In some embodiments, the transceiving module 204 may inform the consumer 102A about a charge of selected service/job like live video call communication or home visit. The charge may be an approximate or exact charge. For example, the charge may be like $5 per minute of call or home $10 for per minute of home visit, after completion of the job, the fee may be calculated according to the duration of the job and the charge as agreed upon initially as per the terms and conditions.

The transceiving module 204 is also configured to send a job request notification to the plurality of tradesman 108A-108N based on the job request. The job request notification may include a short description of a job and a distance between the location of the consumer 102A and the plurality of tradesman108A-108N. An example of the job request notifications sent to the tradesman 108A-108N may include “Rahul Smith Over heating of AC 0.5 mi1es away”.

In the meantime, until an acceptance of the job request is not received from any tradesman of the plurality of tradesman 108A-108N, the transceiving module 204 may display a list of the plurality of tradesman 108A-108N to the consumer 102A. The consumer 102A may select a tradesman e.g. the tradesman 108A from the list. In some embodiments, the transceiving module 204 receives at least one of a selection of a tradesman e.g. the tradesman 108A of the list from the consumer 102A and/or an acceptance of the job request from a tradesman e.g. a tradesman 108B of the plurality of tradesman 108A-108N. In some embodiments, when the consumer 102A selects the tradesman 108A before any acceptance of the job request is received from the tradesman 108B, then the tradesman 108A wins the job. In other embodiments, if the acceptance of the job request is received from the tradesman 108B before receiving the selection of the tradesman 108A, then the tradesman 108B wins the job. In alternate embodiments, the tradesman 108A selected by the consumer 102A is given priority and may win the job even if the acceptance of the job request from the tradesman 108B is received before the selection of the tradesman 108A by the consumer 102A. For the sake of describing the functionality of the live video communication system 106, lets assume that the tradesman 108B wins accepts the job request and wins the job.

For the home visit or home call out job request, the at least one tradesman 108B who accepts the job request is committed to arrive at the location within a timeframe after accepting the job request. In an embodiment, the job request is accepted by the tradesman 108B of the plurality of tradesman 108A-108B based on first come first serve basis.

The job managing module 206 configured to assign a job to at least one tradesman of the tradesman selected by the consumer 102A and the tradesman 108B who accepted the job request. One or more details of the consumer 102A including a location of the consumer 102A, a name of the consumer 102A, etc. may be sent to the at least one tradesman 108B for assigning the job. The location of the consumer 102A is sent to the at least one tradesman 108B by using a Geo Positioning System (GPS). In some embodiments, the job is assigned to the at least one tradesman 108B based on at least one of a proximity to the location, a response from the tradesman 108, a received selection of the tradesman 108A from the consumer 102A, a skillset of the tradesman 108, a timeframe commitment of the tradesman 108 for reaching at the location. In some embodiments, the transceiving module 204 is also configured to share one or more details of the at least one tradesman 108B with the consumer 102A after assignment of the job.

The communication module 208 configured to arrange at least one of a live video call session between the consumer 102A and the at least one tradesman 108B or a home visit of the at least one tradesman 108B at the location of the consumer 102A based on the selection of the at least one mode of communication. In some embodiments, the consumer 102A initiates the live video call session with the at least one tradesman 108B. In case of live video call/chat scenario; the tradesman 108B who is first to accept the job wins the job for live video chat, then may be connected to the consumer 102A in emergency ASAP. Then via the live video call (or chat), the tradesman 102A (e.g. electrician or plumber) can instruct the consumer 102A on the emergency. For example, if the consumer 102A selected live video call session mode then a live video call session may be established between the consumer 102A and the tradesman 108B. In some embodiments, the consumer 102A initiates the live video call session with the at least one tradesman 108B. The live video communication system 106 may link any user comprising the consumers 102A-102N or the plurality of tradesman 108A-108N using any computing device platform through a website or application to connect via the live video call. Further, the tradesman 108B, like a plumber, can use a camera lens of the computing device of the consumer 102A to zoom in and out to help make the experience less stressful for the consumer 102A. So the consumer 102A can just hold the computing device, like phone, to show the tradesman 108B on camera the problem so the consumer 102A and the tradesman 108B can use their hands and hold the computing device at the same time. Also the tradesman 108B can turn torch on consumer's computing device to help solve the problem.

In case of the home visit mode of communication selection by the consumer 102A, the tradesman 108B wins the job for emergency home visit or home call out, then automatically after call maps will pin point consumer location for the tradesman 108B to use as GPS to get to the destination ASAP to help the consumer 102A at the location in emergency. The live video communication system 106 may receive a job completion notification from the consumer 102A based on at least one of an end of the live video call session or completion of the home visit. The at least one tradesman 108B may be committed to arrive at the location within a timeframe after accepting the job request. The tradesman 108B may be charged with a delay fee or an amount may be deducted from an account of the tradesman 108B. The payment managing module 210 may charge the delay fee or deduct the amount from the account of the tradesman 108B.

Further, the consumer 102A may end the call for ending the live video call session. In some embodiments, the communication module 208 is also configured to prompt the consumer 102A to confirm ending the live video call after receiving an end call request from the consumer 102A to double check with the consumer 102A and ending the live video call session upon receiving an end call confirmation input from the consumer 102A. Therefore, the live video communication system 202 is a two-touch end call system to help stop ending the live video call by accident. In some embodiments, the transceiving module 204 is configured to receive a job completion notification from the consumer 102A based on at least one of an end of the live video call session or completion of the home visit.

In some embodiments, the tradesman 108B may send an email to the consumer 102A after their recorded live video call/chat session via the transceiving module 204 for future reference of the consumer 102A. In some embodiments, the consumer 102A uses a first computing device such as, an iPhone having a first operating system e.g. iOS and the tradesman 108B using a second computing device e.g. a Samsung mobile having a second operating system e.g. Android Oreo.

The payment managing module 210 is configured to calculate a fee for the job based on one or more parameters on completion of at least one of the live video call or the home visit, wherein the one or more parameters comprising a duration of the job, a type of the at least one tradesman, a type of the trade service, and the terms and conditions. The payment managing module 210 may charge an account of the consumer according to the calculated fee. The payment managing module 210 is configured to make a payment to the at least one tradesman 108B for a completed job based on one or more factors. The one or more factors may include, but are not limited to, a type of the job, a duration of the job, travel cost, a skillset of the tradesman 108B, and an arrival time for the home visit. For the home visit, when the tradesman 108B fails to arrive at the location of the consumer 102A within fixed timeframe or arrives later than a predefined time than the payment managing module 210 may charge a delay fee or may deduct an amount directly from their payment account like a bank account.

The database 212 may store the information of the consumers 102A-102N, the tradesman 108A-108N, the network 104, the account information of the consumers 102A-102N, the account information of the consumers the tradesman 108A-108N, and so forth. The network interface 214 may connect the live video communication system 202 with the network 104. In some embodiments, the database 212 may store the job history of the consumers 102A-102N and the plurality of tradesman 108A-108N.

In some embodiments, the live video communication system 202 may be a web platform. In some embodiments, the live video communication system 202 may be a cloud based system.

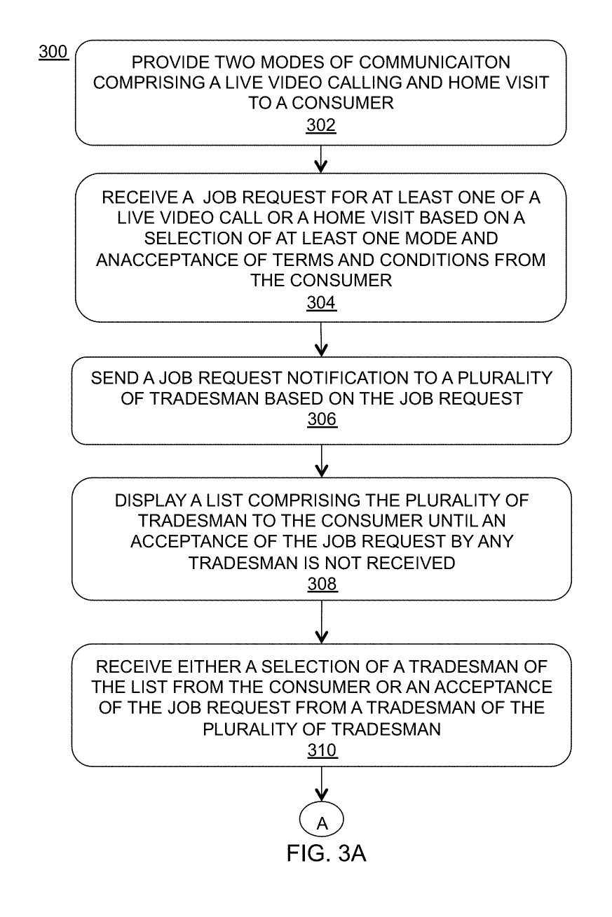

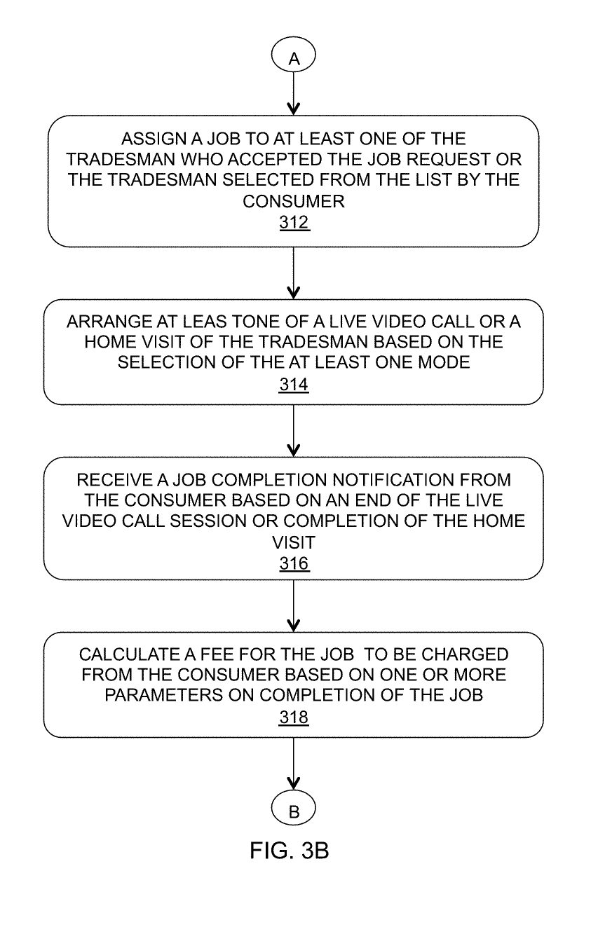

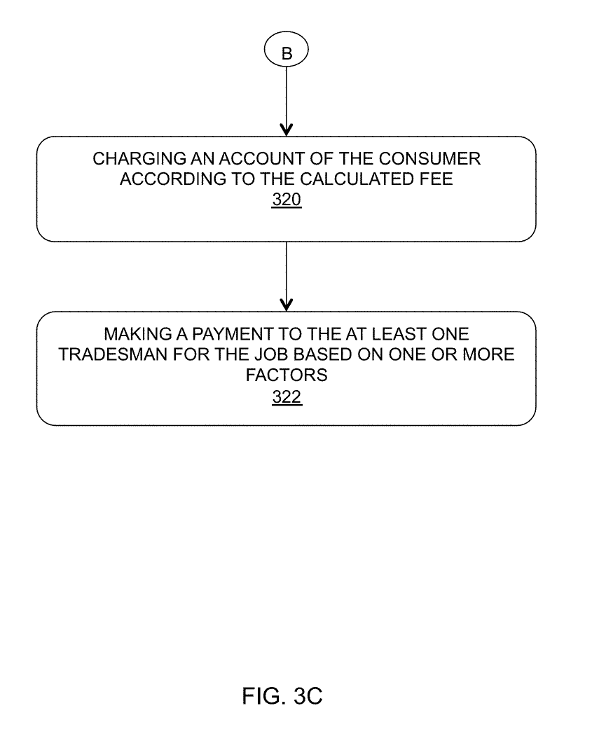

FIGS. 3A-3C is a flowchart illustrating a method 300 for processing a document by classifying one or more clauses present in the document, in accordance with an embodiment of the present disclosure. As discussed with reference to FIG. 1 and FIG. 2, the consumers 102A-102N may place a job request for a tradesman of the plurality of tradesman 108A-108N for a trade service or an emergency trade service via a live video communication system 106 or 202. For example, the consumer 102 may access the live video communication system 202 for hiring a tradesman 108 for an emergency trade service like plumbing of a water heater in case of water heater burst.

The method initiates at step 302, the live video communication system 202 may present the consumer 102 with two modes of communication comprising a live video call mode of communication and a home visit mode of communication. The consumer 102 may select one of these two modes of communication. For example, for explanation purpose of the method lets assume the consumer 102 selects the live video call mode of communication on his/her associated computing device.

Then at step 304, the transceiving module 204 receives a job request for at least one of a live video call or a home visit based on a selection of the mode of the communication from the consumer 102. As the consumer 102 selected live video call mode of communication, then the transceiving module 204 receives the job request according to the live video call mode of communication from the consumer 102. The transceiving module 204 may also present a charge of service or job to the consumer 102 based on the selection of the mode of communication. For example, $4 per minute for a live video call/chat and $7 per minute for a home visit. The exact charge or fee may be calculated at the completion of the job later. In some embodiments, a live call may be followed by a home visit depending on the conversation between the consumer 102A and the tradesman 108B over the live video call.

At step 306, the transceiving module 204 sends a job request notification to the plurality of tradesman 108A-108N skilled for the trade service or the emergency trade service i.e. plumbing here based on the job request. The job request notification may include a short description of job and a mile range or distance between the consumer 102 and the tradesman 108A-108N. For example, John Smith Burst pipe 0.8 miles away. John smith may be name of the consumer 102A, burst pipe is the issue and 0.8 miles is the distance. At step 308, a list of plurality of tradesman 108A-108N may be displayed to the consumer 102 on his/her computing device until an acceptance of the job request is not received from any of the tradesman 108A-108N. The transceiving module 204 may display the list. The consumer 102A can select a tradesman from the list. The list may include a short description about each of the tradesman 108A-108N to help the consumer 102A to select one tradesman.

At step 310, the transceiving module 204 may receive either a selection of a tradesman (e.g. 104A) from the list from the consumer 102 or an acceptance of the job request from a tradesman (e.g. 108B) of the tradesman 108A-108N. In some embodiments, a tradesman 108 of the plurality of tradesman 108A-108N interested in taking up the job may accept the job based on first come first serve basis and then connect via a live video chat to the consumer 102 if the consumer 102A selected live video call mode of communication, else the tradesman 108 may receive the GPS location of the consumer 102A for home visit.

At step 312, the job managing module 206 assigns a job to at least one of the tradesman 108B who accepted the job request or the tradesman 108A selected by the consumer 102 from the list. Here lets assume, tradesman 108B wins the job, then the job is assigned to the tradesman 108B.

At step 314, the communication module 208 arranges at least one of a live video call between the tradesman 108B and the consumer 102, or a home visit of the tradesman at a location of the consumer 102. As the consumer wanted to have a live video call mode of communication, therefore, a live video call is initiated and established between the tradesman 108B and the consumer 102. In some embodiments, the consumer 102 initiates the live video call with the tradesman 108B after assignment of the job. The consumer 102 may show or describe the problem to the tradesman in detail over the live video call. It's usually easy to show then tell in words exactly what the problem is. For example, if the water pipeline has burst, the consumer 102 may direct the camera of the computing device towards the burst water pipeline so that the tradesman 118B understands better.

Then at step 316, the transceiving module 204 receives a job completion notification from the consumer 102 based on an end of the live video call or completion of home visit. Here, the job completion notification is received on end of the live video call; the consumer 102 may end the live video call. In some embodiments, the communication module 208 is also configured to prompt the consumer 102 to confirm ending the live video call after receiving an end call request from the consumer 102 to double check with the consumer 102 and ending the live video call session upon receiving an end call confirmation input from the consumer 102.

Thereafter at step 318, calculate a fee for the job to be charged from the consumer 102 based on one or more parameters on completion of the job. The one or more parameters may include, but are not limited to, a duration of the job, a location for the consumer 102, a type of trade service, and so forth. The fee may automatically be charged from the stored payment details of the consumer 102. In some embodiments, the consumer 102 may be asked to pay via a payment link according to the calculated fee for the completed job. The consumer 102 may also leave a feedback or a review post payment of the fee.

The present disclosure provides a web platform as a system to provide emergency trade services like plumbing, home cleaning, and so forth. The web platform may enable a consumer to hire a tradesman for a tradeservice or an emergency tradeservice. The web platform may provide two choices to a client to solve an emergency problem. First is live video call and second is an emergency home visit of tradesman. After the client makes a choice the web platform may then via gps, notify local emergency tradesman (ex. a Plumber) in an area of the consumer by sending a notification short message of emergency, and a short detail of where the consumer/client is located. Further a first plumber to accept the job or respond to the notificaiton message via notification can win the job, following that if the plumber first to accept the job, wins job for live video chat (or home visit), then is connected to the consumer/client in the emergency asap. Then via live video chat the plumber can instruct the consumer/client and provide the tradeservice over the call itself. In some embodiments, the plumber may tell the consumer that a home visit may also be required for fixing the issue, therefore with consumer permission, the plumber may visit the location of the consumer/client after the end of the live video call. If the plumber wins job for emergency home call out/home visit, then automatically after call maps will pin point the consumer/client location for the plumber to use as GPS to get to the location of the consumer asap to help the consumer/client at home in emergency. The web platform enables the consumer to get the tradeservice over the live video call, as not always a home visit might be required and hence saves time and in turn money of the consumer as issue is resolved in relatively less time without any visit by the plumber (or the tradesman) as home visits are usually expensive.

The present disclosure provides a live video communication system configured to enable a consumer to contact a tradesman for a trade service in an emergency situation over a live video call by using an associated computing device.

The present disclosure provides a live video communication system configured to enable a consumer to contact a tradesman for a trade service in an emergency situation for getting a solution for an emergency issue over a live video call. For example, if a short circuit has happened, the consumer can have a live video call with an electrician via the live video communication system; the electrician may guide the consumer to fix the short circuit issue by himself over the live video call. This way, the consumer can solve the issue in an economical way in terms of money and time. It's a win-win for both consumer and tradesman as its economical for consumers, and for tradesman it saves their time, hence tradesman can resolve multiple issues in a day and earn more money.

The present disclosure provides a live video communication system configured to enable a consumer to contact a tradesman in an emergency situation for arranging a home visit. the system helps the consumer when the consumer have no information of tradesman and would like a tradesman to attend an emergency issue at the earliest. The live video communication system also enables the consumer to establish live video call with the tradesman if the consumer wants before the home visit so that the consumer can explain the tradesman about the issue by showing issue to the tradesman via the video call. This way, the tradesman can come prepared with all tools and resources for handling the emergency issue for the home visit. Hence it will help in fixing the emergency issue in an optimal way.

The present disclosure provides a live video communication system configured to enable a consumer to contact a tradesman for a trade service in case of an emergency. The consumer may contact the tradesman via at least one of a live video call, and a home visit. The live video communication system may share or notify via a short description including location of the consumer and description of the problem that need to be resolved with a plurality of tradesman available for emergency services in an area of the consumer. Then, one or more of the tradesman may respond to the notification or accept a job by responding. The job may be assigned to a tradesman from whom the response is received first. Then a live video call is established between the consumer and the tradesman who accepted the job first if the consumer wanted a live video call. Otherwise, a location of the consumer is pin pointed via GPS to the tradesman, and the tradesman may reach at the location of the consumer within a committed time from the acceptance of the job. In some embodiments, if the tradesman fails to reaches at the located within the committed time, and then the live video communication system may either charge a delay fee or deduct some amount from a security deposit or an account of the tradesman. The consumer may end the live video call or may notify the live video communication system on completing of the home visit. Then, the live video communication system may calculate a fee to be charged for a completed job from the consumer. Thereafter, the live video communication system may charge an account of the consumer for the completed job. In some embodiments, the consumer may be charged an amount in advance, and later a rest of the amount may be charged base don the calculation. In some embodiments, the consumer may be asked to provide his/her payment details at a time of signup or registration with the live video communication system.

The present disclosure provides a live video communication system configured to enable consumers to connect to the live video communication system as a website via a computing device for finding and contacting tradesmen for a trade service primarily an emergency trade service. The consumers can make live video call with the tradesman irrespective of which technology platform they are calling from or for e.g. Android, iOS, Symbian, MeeGo, Maemo, windows, and so forth. The consumers may have a choice to choose a live video call or an emergency home visit. The live video communication system may notify local tradesman in an area of the consumers via GPS by sending a short message of emergency and a short detail of where the consumers are located; for example, a plumber receives a notification “BURST WATER PIPE 0.5M AWAY”.

Based on whether the consumer has chosen for a live video call or the emergency home visit, the live video communication system may establish a communication session i.e. a live video call or a home visit, respectively. First the tradesman (or the plumber) has to accept the job via notification and may win the job. In case of live video call/chat scenario, the tradesman who is first to accept the job wins the job for live video chat, then may be connected to the consumer in emergency ASAP. Then via the live video call (or chat), the tradesman (or plumber) can instruct the consumer on the emergency. In case of the home visit scenario, the tradesman wins the job for emergency home call out, then automatically after call maps will pin point consumer location for tradesman to use as GPS to get to the destination ASAP to help the consumer at the location in emergency.

The disclosed live video communication system may link any user comprising consumer or tradesman using any computing device platform through a website or application to connect via a live video call. Further, a tradesman like a plumber can use a consumer's camera lens to zoom in and out to help make the experience less stressful for the consumer, so the consumer can just hold the computing device like phone to show the plumber on camera the problem so they can use their hands and hold device at same time. Also the plumber or the emergency tradesman can turn torch on consumer's computing device to help solve the problem.

The present disclosure provides a live video communication/chat system configured to enable consumers to speak to emergency trade specialists e.g. plumber, electricians, etc. from their location like home via a live video chat. For example, the consumer can speak over a live video chat to a plumber online to get help and instructions in an emergency situation to fix, repair, fix, or stop the problem.

The present disclosure provides a live video communication system configured to enable users using different type of platform computing devices to have live video calls. For example, the android users can have live video call with apple iPhone users by using the live video communication system. Traditionally, it was not possible for different technology platform computing device users to connect via live video calls. For example, the android users could not connect live video chat with apple iPhone users before because of technology disadvantage. But by suing the live video communication system it can be possible.

Let's understand the method in the context of plumbing services, in this method a user has a choice to choose live video call or emergency home visit after that web platform will then via gps, notifylocal plumbers in their area of notification short message of emergency, and a short detail of where the user is located, for example plumber receives notification:“BURST WATER PIPE 0.5M AWAY”. Whether the userhas chosen on website for live video call or emergency call out plumber will see notification and first come first basis first plumber/emergency tradesman to accept the job via notification will win the job, following that if plumber first to accept job, wins job for live video chat, then is connected to the userin emergency. Then via live videochat plumber can instruct the useron emergency. Plumber wins job for emergency home call out, then automatically after call maps will pin point the userlocation for plumberto use as gps to get to the destination asap to help the user at home in emergency.

The processes described above executing in the live video communication system 106 or 202 may be implemented in firmware, hardware, software, or any combination thereof. The processes are preferably implemented in a computer program or multiple computer programs executing on a programmable computer including a storage medium or database readable by the processor or processing module (including, e.g., volatile and non-volatile memory and/or storage elements), input and output devices, and a processor. Each computer program can be a set of instructions (program code) in a code module resident in the random-access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

The live video communication system may comprise a physical machine or multiple physical machines, or virtual machines running on a physical machine or multiple physical machines. In addition, the server computer system may comprise a cluster of computers or multiple distributed computers that are connected by the network or the Internet.

Method claims set forth below having steps that are designated by letters or numbered should not be considered to be necessarily limited to the particular order in which the steps are recited.

Embodiments of the disclosure are also described above with reference to flowchart illustrations and/or block diagrams of methods and systems. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks. These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks. The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the acts specified in the flowchart and/or block diagram block or blocks.

In addition, methods and functions described herein are not limited to any particular sequence, and the acts or blocks relating thereto can be performed in other sequences that are appropriate. For example, described acts or blocks may be performed in an order other than that specifically disclosed, or multiple acts or blocks may be combined in a single act or block.

While the invention has been described in connection with what is presently considered to be the most practical and various embodiments, it is to be understood that the invention is not to be limited to the disclosed embodiments, but on the contrary, is intended to cover various modifications and equivalent arrangements.

The embodiments described above are intended only to illustrate and teach one or more ways of practicing or implementing the present invention, not to restrict its breadth or scope. The actual scope of the invention, which embraces all ways of practicing or implementing the teachings of the invention, is defined only by the following claims and their equivalents.

What is claimed is:

1. A live video communication system for trade services, comprising:
a transceiving module configured to:
provide at least two modes of communication comprising a live video call and a home visit to a consumer, wherein the consumer selects at least one mode of the two modes;
receive a job request for at least one of a live video call or a home visit based on the selection of the at least one mode, and an acceptance of terms and conditions from the consumer, wherein the job request is for contacting a tradesman for a trade service;
send a job request notification to a plurality of tradesman based on the job request, wherein a list of the plurality of tradesman is displayed to the consumer until an acceptance of the job request is not received from any tradesman; and
receive at least one of a selection of a tradesman of the list from the consumer and an acceptance of the job request from a tradesman of the plurality of tradesman;
a job managing module configured to assign a job to at least one tradesman of the tradesman selected by the consumer and the tradesman who accepted the job request, wherein one or more details of the consumer comprising a location of the consumer are sent to the at least one tradesman for assigning the job;
a communication module configured to arrange at least one of a live video call session between the consumer and the at least one tradesman or a home visit of the at least one tradesman at the location of the consumer based on the selection of the at least one mode; and
a payment managing module configured to:
calculate a fee for the job based on one or more parameters on completion of at least one of the live video call or the home visit, wherein the one or more parameters comprising a duration of the job, a type of the at least one tradesman, a type of the trade service, and the terms and conditions; and
charge an account of the consumer according to the calculated fee.

2. The live video communication system of claim 1, wherein the communication module is also configured to prompt the consumer to confirm ending the live video call after receiving an end call request from the consumer to double check with the consumer and ending the live video call session upon receiving an end call confirmation input from the consumer.

3. The live video communication system of claim 1, wherein the at least one tradesman is committed to arrive at the location within a timeframe after accepting the job request.

4. The live video communication system of claim 3, wherein the payment managing module is configured to make a payment to the at least one tradesman for a completed job based on one or more factors.

5. The live video communication system of claim 1, wherein the job request is accepted by the tradesman of the plurality of tradesman based on first come first serve basis.

6. The live video communication system of claim 1, wherein the transceiving module is configured to:
share one or more details of the at least one tradesman with the consumer after assignment of the job, wherein the consumer initiates the live video call session with the at least one tradesman; and
receive a job completion notification from the consumer based on at least one of an end of the live video call session or completion of the home visit.

7. The live video communication system of claim 1, wherein the job request notification comprises a short description of a job and a distance between the location of the consumer and the at least one tradesman.

8. The live video communication system of claim 1, wherein the location of the consumer is sent to the at least one tradesman by using a Geo Positioning System (GPS).

9. A method for live video communication for trade services, comprising:
providing two modes of communication comprising a live video call and a home visit to a consumer, wherein the consumer selects at least one mode of the two modes;
receiving a job request for at least one of a live video call or a home visit based on the selection of the at least one mode, and an acceptance of terms and conditions from the consumer, wherein the job request is for contacting a tradesman for a trade service;
sending a job request notification to a plurality of tradesman based on the job request, wherein a list of the plurality of tradesman is displayed to the consumer until an acceptance of the job request is not received from any tradesman;
receiving at least one of a selection of a tradesman of the list from the consumer and an acceptance of the job request from a tradesman of the plurality of tradesman;
assigning a job to at least one tradesman of the tradesman selected by the consumer and the tradesman who accepted the job request, wherein one or more details of the consumer comprising a location of the consumer are sent to the at least one tradesman for assigning the job;
arranging at least one of a live video call session between the consumer and the at least one tradesman or a home visit of the at least one tradesman at the location of the consumer based on the selection of the at least one mode;
calculating a fee for the job based on one or more parameters on completion of at least one of the live video call or the home visit, wherein the one or more parameters comprising a duration of the job, a type of the at least one tradesman, a type of the trade service, and the terms and conditions; and
charging an account of the consumer according to the calculated fee.

10. The method of claim 9 further comprising prompting the consumer to confirm ending the live video call after receiving an end call request from the consumer to double check with the consumer and ending the live video call upon receiving an end call confirmation input from the consumer.

11. The method of claim 9, wherein the at least one tradesman is committed to arrive at the location within a timeframe after accepting the job request.

12. The method of claim 11 further comprising making a payment to the at least one tradesman for a completed job based on one or more factors.

13. The method of claim 11 further comprising charging a delay fee when the at least one tradesman is not able to reach at the location of the consumer within the time frame.

14. The method of claim 9 further comprising accepting the job request, by the tradesman of the plurality of tradesman, based on first come first serve basis.

15. The method of claim 9 further comprising:
sharing one or more details of the at least one tradesman with the consumer after assignment of the job, wherein the consumer initiates the live video call session with the at least one tradesman; and
receiving a job completion notification from the consumer based on at least one of an end of the live video call session or completion of the home visit.

16. The method of claim 9, wherein the job request notification comprises a short description of a job and a distance between the location of the consumer and the at least one tradesman.

17. The method of claim 9, wherein the location of the consumer is sent to the at least one tradesman by using a Geo Positioning System (GPS).

18. A live video communication system for managing a communication between a tradesperson and a consumer for an emergency trade service, comprising:
a transceiving module configured to:
provide two modes of communication comprising a live video call and a home visit to a consumer, wherein the consumer selects at least one mode of the two modes;
receive a job request for at least one of a live video call or a home visit based on the selection of the at least one mode, and an acceptance of terms and conditions from the consumer, wherein the job request is for contacting a tradesperson for an emergency trade service;
send a job request notification based on the job request to a plurality of tradesperson present in a local area of the consumer, wherein the job request notification comprises a short description of a job and a distance between a location of the consumer and the at least one tradesperson, wherein a list of the plurality of tradesperson is displayed to the consumer until an acceptance of the job request is not received from any tradesperson; and
receive at least one of a selection of a tradesperson of the list from the consumer and an acceptance of the job request from a tradesperson of the plurality of tradesperson;
a job managing module configured to assign the job to at least one tradesperson of the tradesperson selected by the consumer and the tradesperson who accepted the job request, wherein the location of the consumer is sent to the at least one tradesperson by using a Geo Positioning System (GPS) for assigning the job, wherein one or more details of the at least one tradesperson are shared with the consumer after assignment of the job;
a communication module configured to arrange at least one of a live video call session between the consumer and the at least one tradesperson or a home visit of the at least one tradesperson at the location of the consumer based on the selection of the at least one mode; and
a payment managing module configured to:
calculate a fee for the job based on one or more parameters comprising a duration of the job, a type of the at least one tradesperson, a type of the trade service, and the terms and conditions after completion of the job;
charge an account of the consumer according to the calculated fee; and
make a payment to the at least one tradesperson for the job based on one or more factors;
wherein the transceiving module receives a job completion notification from the consumer based on at least one of an end of the live video call session or completion of the home visit.

19. The live video communication system of claim 1, wherein the communication module is also configured to prompt the consumer to confirm ending the live video call after receiving an end call request from the consumer to double check with the consumer and ending the live video call upon receiving an end call confirmation input from the consumer.

20. The live video communication system of claim 1, wherein the consumer uses a first computing device having a first operating system and the tradesman using a second computing device having a second operating system.
